(19) United States
(12) Patent Application Publication
(10) Pub. No.: US 2026/0208300 A1
(43) Pub. Date: Jul. 23, 2026

(54) WAFER PRODUCTION METHOD

(71) Applicant: DISCO CORPORATION, Tokyo (JP)

(72) Inventors: Ryosuke SAKURAI, Tokyo (JP); Yuya SETO, Tokyo (JP)

(21) Appl. No.: 19/448,348

(22) Filed: Jan. 14, 2026

(30) Foreign Application Priority Data
Jan. 17, 2025 (JP) 2025-006931

(51) Int. Cl. B23K 26/53; B23K 101/40

(52) U.S. Cl. CPC B23K 26/53; B23K 2101/40

(57) ABSTRACT

A wafer production method includes: holding the workpiece; forming a separation layer in an outer peripheral region of the workpiece as defined herein; forming a separation layer in an inner region inside the outer peripheral region of the workpiece as defined herein; and separating a plate-shaped object from the workpiece as the wafer with the separation layers formed in the outer peripheral region and the inner region as a start point, and in the forming of the separation layer in the outer peripheral region, the laser beam is applied to the outer peripheral region of the workpiece such that an output of the laser beam at an outer position in the outer peripheral region is higher than an output at an inner position in the outer peripheral region.

### CROSS-REFERENCE TO RELATED APPLICATIONS

This application is based on and claims priority under 35 USC 119 from Japanese Patent Application No. 2025-006931 filed on January 17, 2025, the contents of which are incorporated herein by reference.

### TECHNICAL FIELD

The present disclosure relates to a wafer production method for producing a wafer from a workpiece.

### BACKGROUND ART

As a method for producing a wafer such as a semiconductor, Patent Literature 1 describes a method in which a laser beam having a transmission wavelength is focused and applied to a gallium nitride (GaN) ingot from a front surface side thereof to form a separation layer including a modified layer and a crack extending from the modified layer inside the ingot, and then a plate-shaped object is separated from the ingot to produce a wafer.

When laser processing is performed on the GaN ingot, bonds between gallium atoms and nitrogen atoms are broken, generating nitrogen gas inside the ingot. Due to the nitrogen gas, abnormal volume expansion may occur in the separation layer on a radially inner side of the ingot, and the ingot may be damaged. Patent Literature 1 describes a method in which a nitrogen gas outlet is formed by first applying a laser beam to an outer peripheral region of an ingot to form a separation layer exposed at an outermost peripheral edge of the ingot.

Patent Literature 1: JP2023-181727A

### SUMMARY OF INVENTION

In order to reliably form the separation layer exposed at the outermost peripheral edge of the workpiece, it is necessary to apply a high-power laser beam. In this case, the load on the wafer to be produced increases, resulting in problems such as processing defects and increased material loss.

The present disclosure provides a wafer production method that can reliably form, in an outer peripheral region of a workpiece, a separation layer capable of discharging gas generated inside the workpiece during laser processing, and that can reduce the output of a laser beam to be applied.

According to the present disclosure, there is provided a wafer production method for producing a wafer thinner than a workpiece, which is a nitride or oxide semiconductor, from the workpiece, the wafer production method including:

### a holding step of holding the workpiece;

a first separation layer forming step of forming a separation layer in an outer peripheral region of the workpiece held in the holding step by applying a pulsed laser beam having a wavelength that passes through the workpiece to the outer peripheral region of the workpiece, with a focal point of the laser beam positioned at a predetermined depth from a front surface of the workpiece;

a second separation layer forming step of forming a separation layer in an inner region inside the outer peripheral region of the workpiece by applying the laser beam to the inner region with the focal point of the laser beam positioned at the predetermined depth from the front surface of the workpiece, after the first separation layer forming step; and

a separating step of separating a plate-shaped object from the workpiece as the wafer with the separation layers formed in the first separation layer forming step and the second separation layer forming step as a start point, in which

in the first separation layer forming step, the laser beam is applied to the outer peripheral region such that the output at an outer position is higher than the output at an inner position in the outer peripheral region of the workpiece.

### BRIEF DESCRIPTION OF DRAWINGS

FIG. 1 is a perspective view illustrating a laser processing apparatus.

FIG. 2 is a diagram illustrating a laser beam applying mechanism.

FIG. 3 is a diagram illustrating a laser beam applying mechanism according to a modification.

FIG. 4 is an example of a flowchart of a wafer production method.

FIG. 5 is a top view of an ingot in which an example of a separation layer formed in an outer peripheral region of the ingot in a first separation layer forming step is indicated by a broken line.

FIG. 6 is a diagram illustrating an example of laser processing in the first separation layer forming step.

FIGS. 7A and 7B are diagrams illustrating a first modification of the laser processing in the first separation layer forming step.

FIGS. 8A and 8B are diagrams illustrating a second modification of the laser processing in the first separation layer forming step.

FIG. 9 is a photograph of the outer peripheral region of the ingot when a laser beam is applied such that the output at an inner position is lower than the output at an outer position in the outer peripheral region of the ingot.

FIG. 10 is a photograph of the outer peripheral region of the ingot when a high-power laser beam is uniformly applied to the outer peripheral region.

FIG. 11 is a diagram illustrating a second separation layer forming step.

FIGS. 12A and 12B are diagrams illustrating a separating step.

### DESCRIPTION OF EMBODIMENTS

Hereinafter, an embodiment of a wafer production method of the present disclosure will be described with reference to the accompanying drawings.

First, a laser processing apparatus 1 used in the wafer production method will be described.

### Laser Processing Apparatus

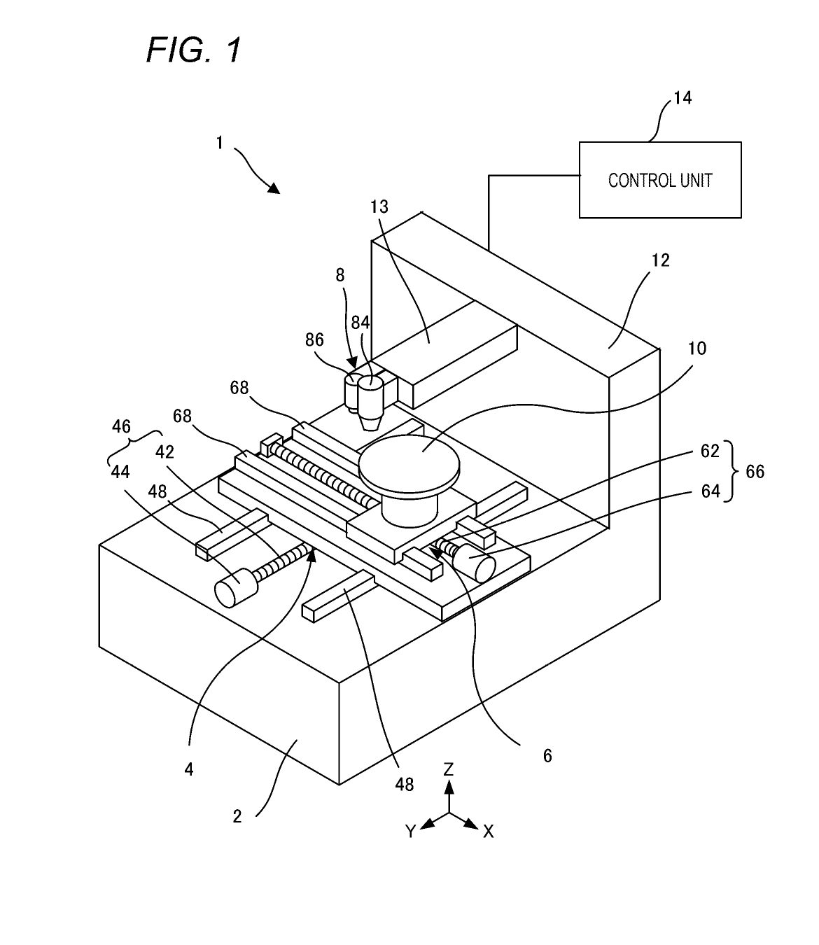

FIG. 1 is a perspective view illustrating the laser processing apparatus 1. In the following description, an X-axis direction is a direction on a horizontal plane. A Y-axis direction is a direction orthogonal to the X-axis direction on the horizontal plane. A Z-axis direction is a direction orthogonal to the X-axis direction and the Y-axis direction.

The laser processing apparatus 1 of the present embodiment includes a base 2, a first slide block 4 mounted on the base 2 so as to be movable in the Y-axis direction, a second slide block 6 mounted above the first slide block 4 and movable in the X-axis direction, a holding table 10 provided on the second slide block 6, a column 12 erected on the base 2, a laser beam applying mechanism 8 attached to the column 12, and a control unit 14 that controls the laser processing apparatus 1.

The first slide block 4 is movable in an indexing direction, that is, the Y-axis direction along a pair of guide rails 48 by an indexing mechanism 46 including a ball screw 42 and a pulse motor 44.

The second slide block 6 is mounted above the first slide block 4 so as to be movable in the X-axis direction. That is, the second slide block 6 is movable in a feeding direction, that is, the X-axis direction along a pair of guide rails 68 by a feeding mechanism 66 including a ball screw 62 and a pulse motor 64.

The holding table 10 is mounted on the second slide block 6. The holding table 10 is movable in the X-axis direction and the Y-axis direction by the feeding mechanism 66 and the indexing mechanism 46, and is rotatable by a motor accommodated in the second slide block 6.

The column 12 is erected on the base 2, and the laser beam applying mechanism 8 is attached to the column 12.

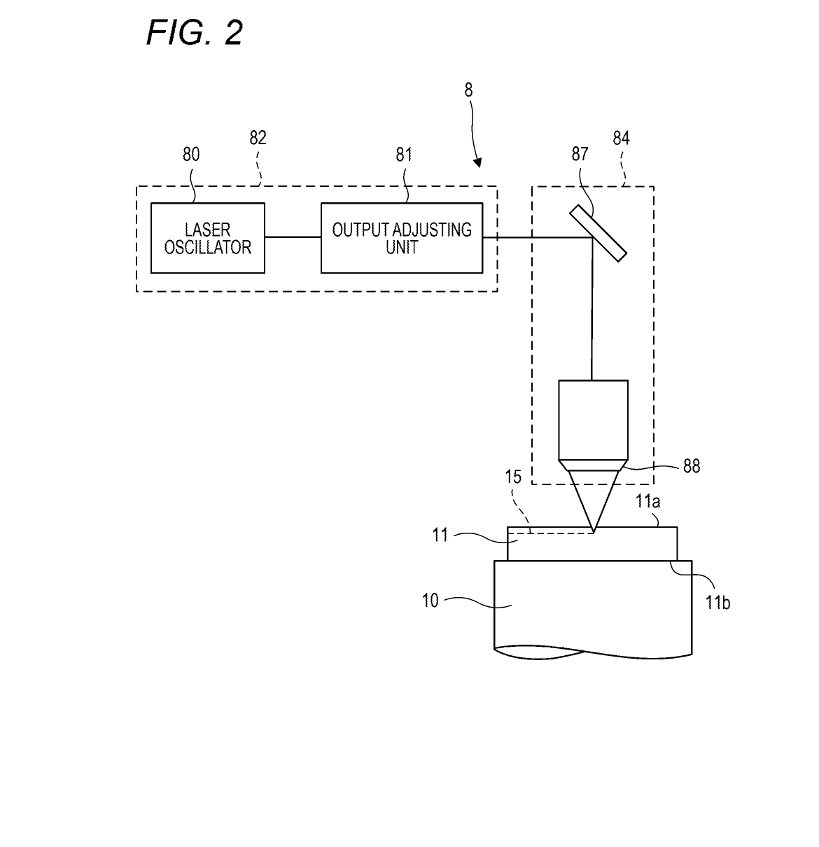

FIG. 2 is a diagram illustrating the laser beam applying mechanism 8. As illustrated in FIGS. 1 and 2, the laser beam applying mechanism 8 includes a laser beam generating unit 82 accommodated in a casing 13 and a focusing means (laser head) 84 attached to a tip end of the casing 13. An imaging unit 86 having a microscope and a camera is attached adjacent to the focusing means 84 at the tip end of the casing 13.

The laser beam generating unit 82 includes a laser oscillator 80 that oscillates a YAG laser or a YVO4 laser, and an output adjusting unit 81. Although not particularly illustrated, the laser oscillator 80 has a Brewster window, and the laser beam emitted from the laser oscillator 80 is a linearly polarized laser beam.

The output adjusting unit 81 adjusts the output of the laser beam to a predetermined power. The laser beam whose output is adjusted is reflected by a mirror 87 of the focusing means 84, and then applied to an ingot 11 (an example of a workpiece) fixed to the holding table 10 at a focal point positioned inside the ingot 11 by a focusing lens 88.

The ingot 11 is made of a nitride or oxide semiconductor material, and is, for example, an ingot made of gallium nitride, gallium oxide, or silicon nitride. The ingot 11 is not limited to a single crystal ingot and may be a polycrystalline ingot. The ingot 11 has a front surface 11a and a back surface 11b opposite to the front surface 11a. The front surface 11a of the ingot 11 is polished into a mirror finish as the front surface 11a is the surface to be applied with the laser beam.

The control unit 14 controls each of the above components of the laser processing apparatus 1 to execute various processes on the workpiece. The control unit 14 is a computer including a controller that performs various calculations, a storage unit having a storage medium, and an input and output interface (not illustrated) that controls input and output of data between the inside and outside of the control unit 14. The controller includes, for example, a processor such as a central processing unit (CPU). The storage unit includes a memory such as a hard disk drive (HDD), a read only memory (ROM), or a random access memory (RAM). The controller performs various calculations based on predetermined programs stored in the storage unit. The controller outputs, according to calculation results, various control signals to the above components via the input and output interface, and controls each of the components of the laser processing apparatus 1.

As illustrated in FIG. 2, the laser processing apparatus 1 forms a separation layer 15 including a plurality of modified regions and cracks extending from the modified regions inside the ingot 11. When forming the separation layer 15, the laser processing apparatus 1 sets a focal point of a laser beam having a wavelength that passes through the ingot 11 held by the holding table 10 at a position deeper than the front surface 11a of the ingot 11, and forms modified regions and cracks by focusing and applying the laser beam from the front surface 11a of the ingot 11.

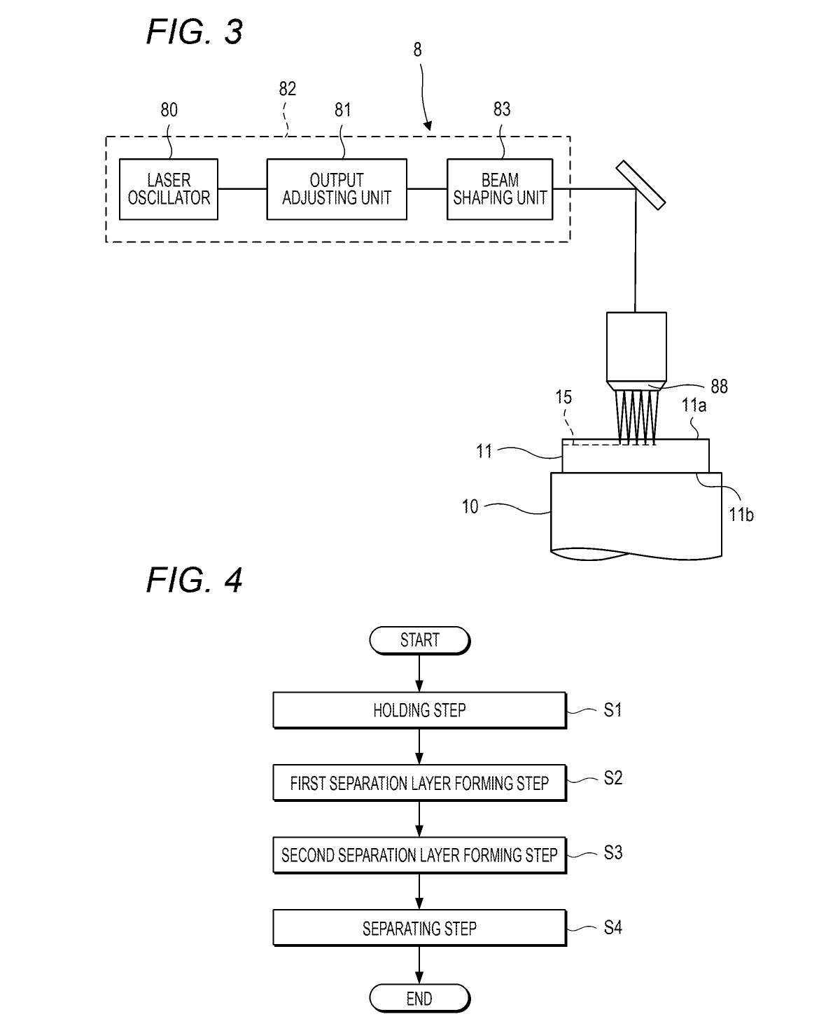

The laser beam applying mechanism 8 is not limited to the above configuration. FIG. 3 is a diagram illustrating a laser beam applying mechanism 8 according to a modification. In the laser beam applying mechanism 8 according to the modification, the laser beam generating unit 82 further includes a beam shaping unit 83 in addition to the laser oscillator 80 and the output adjusting unit 81.

The beam shaping unit 83 can, for example, branch the laser beam into a plurality of laser beams at predetermined intervals in a predetermined direction as illustrated, or shape the laser beam such that the focal point has a shape (for example, an elliptical shape) that extends in a predetermined direction. Accordingly, it is possible to enlarge the region where modified regions and cracks are formed by one application of the laser beam.

### Wafer Production Method

Next, the embodiment of the wafer production method of the present disclosure will be described.

FIG. 4 is a flowchart of the embodiment of the wafer production method. The wafer production method includes a holding step S1 of holding the back surface 11b of the ingot 11, a first separation layer forming step S2 of forming the separation layer 15 by applying a laser beam to an outer peripheral region A1 of the ingot 11, a second separation layer forming step S3 of forming the separation layer 15 by applying a laser beam to an inner region A2 of the ingot 11 after the first separation layer forming step S2, and a separating step S4 of separating a plate-shaped object as a wafer W from the ingot 11 with the separation layers 15 formed in the first separation layer forming step S2 and the second separation layer forming step S3 as a start point. The process of each step is executed by the control unit 14.

### Holding Step

In the holding step S1, as illustrated in FIGS. 2 and 3, the back surface 11b of the ingot 11 is held by the holding table 10.

### First Separation Layer Forming Step

As described above, the ingot 11 is made of a nitride or oxide semiconductor material. Therefore, when laser processing is performed by the laser processing apparatus 1, nitrogen gas or oxygen gas is generated inside the ingot 11 (specifically, in the modified regions and cracks). If the gas expands, the ingot 11 may be damaged during laser processing.

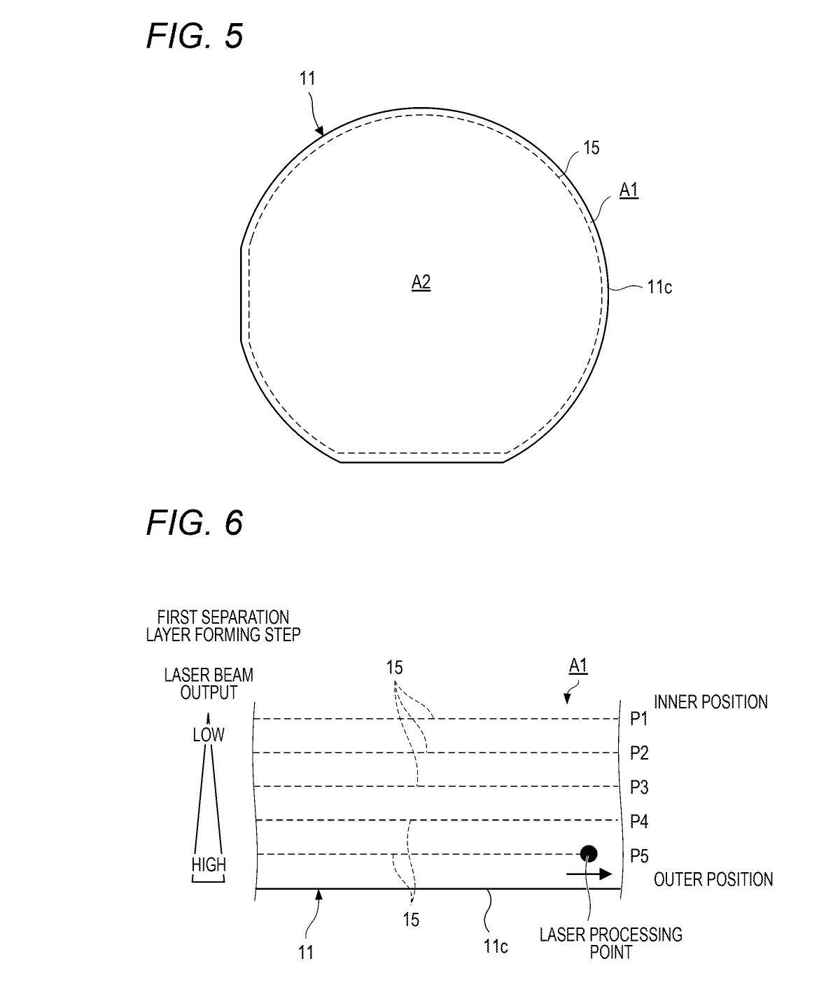

In order to prevent the damage due to the gas expansion, as illustrated in FIG. 5, in the first separation layer forming step S2, the laser beam is first applied to the outer peripheral region A1 of the ingot 11 to form the separation layer 15 (broken line) exposed at the outermost peripheral edge 11c of the ingot 11. Here, the outer peripheral region A1 of the ingot 11 is a region extending from the outermost peripheral edge 11c of the ingot 11 to a position a predetermined distance (for example, about 100 μm to 200 μm) inward. The outermost peripheral edge 11c of the ingot 11 is a side surface of the ingot 11.

More specifically, in the first separation layer forming step S2, a pulsed laser beam having a wavelength that passes through the ingot 11 is applied to the outer peripheral region A1 of the ingot 11 held in the holding step S1, with a focal point of the laser beam positioned at a predetermined depth from the front surface 11a, thereby forming the separation layer 15 in the outer peripheral region A1 of the ingot 11.

Accordingly, the separation layer 15 exposed at the outermost peripheral edge 11c of the ingot 11, that is, a gas outlet can be formed, and the gas generated inside the ingot 11 can be discharged.

Incidentally, in order to reliably form the separation layer 15 exposed at the outermost peripheral edge 11c, it is necessary to apply a high-power laser beam. When a high-power laser beam is applied to the entire outer peripheral region A1 of the ingot 11, the load on the wafer W to be produced increases, resulting in problems such as processing defects and increased material loss.

Therefore, in the first separation layer forming step S2, the output of the laser beam to be applied to the outer peripheral region A1 of the ingot 11 is adjusted by the output adjusting unit 81 of the laser beam applying mechanism 8 such that the output differs between an outer position and an inner position in the outer peripheral region A1. Specifically, in the first separation layer forming step S2, the laser beam is applied to the outer peripheral region A1 such that the output at the outer position is higher than the output at the inner position in the outer peripheral region A1. The outer position of the outer peripheral region A1 is a position close to the outermost peripheral edge 11c of the ingot 11, and the inner position is a position closer to the inner region A2 of the ingot 11 than the outer position.

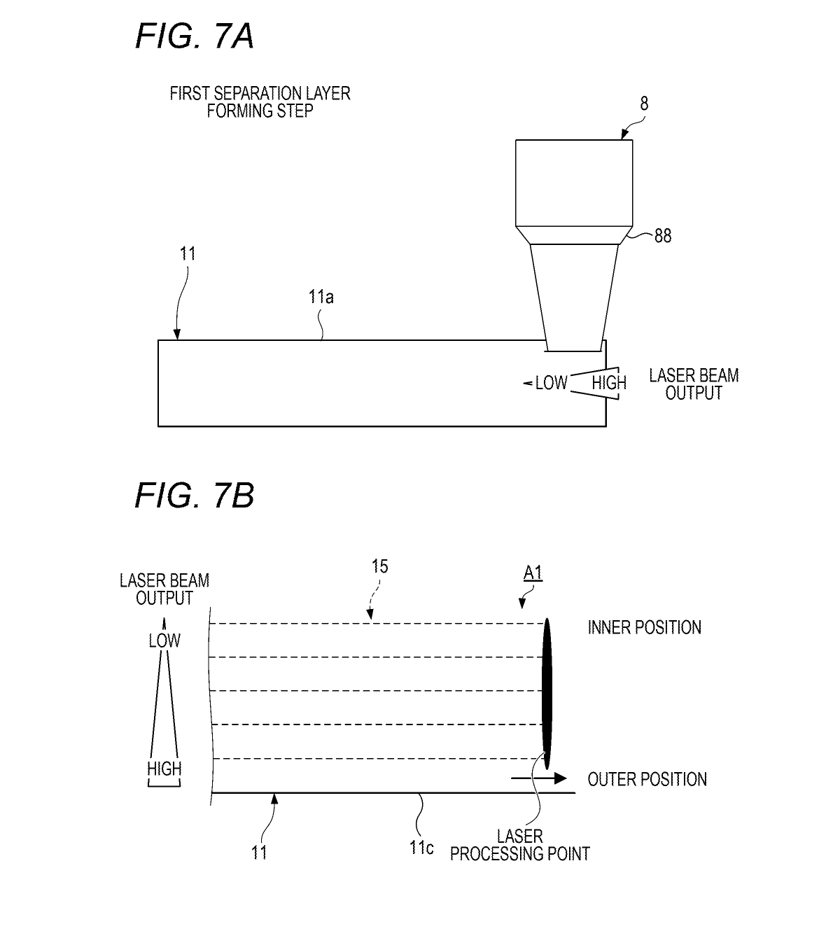

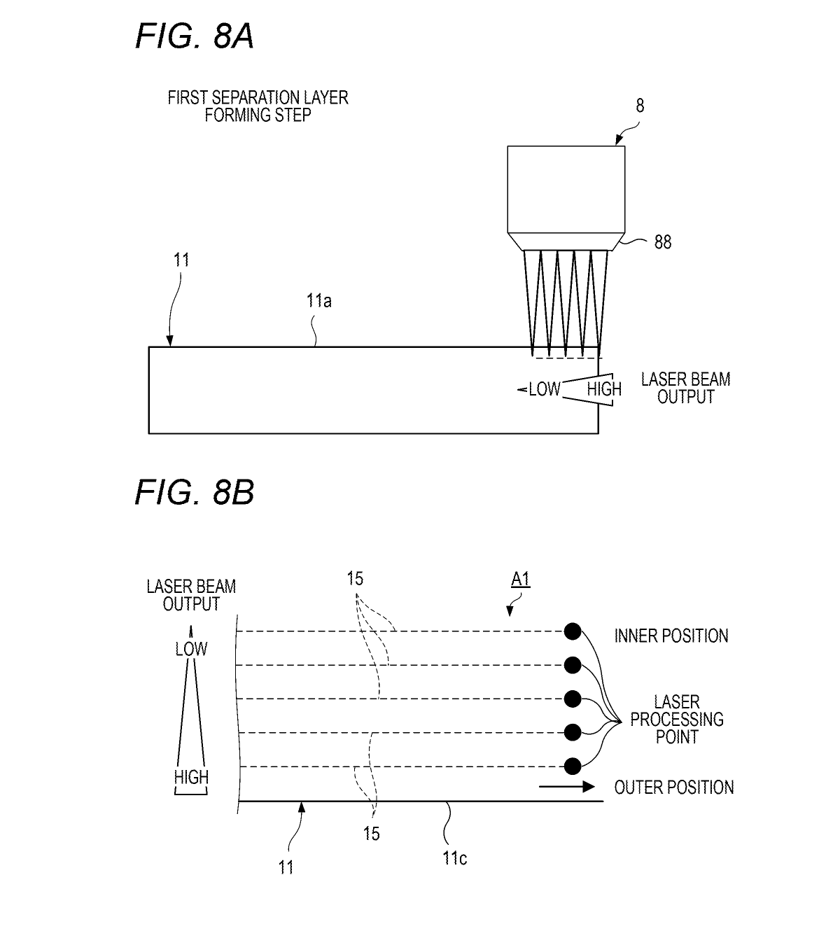

FIG. 6 is a diagram illustrating an example of the laser processing in the first separation layer forming step S2. FIG. 6 illustrates an enlarged part of the outer peripheral region A1 of the ingot 11. In FIG. 6, the separation layer 15 is simplified and illustrated by a broken line (the same applies to FIGS. 7A, 7B, 8A, and 8B to be described later).

In the example illustrated in FIG. 6, in the first separation layer forming step S2, the separation layer 15 is formed by sequentially applying a laser beam from the inner position to the outer position of the outer peripheral region A1. Specifically, in the first separation layer forming step S2, a focal point of the laser beam is positioned at a position P1 included in the inner position of the outer peripheral region A1, and the laser beam is repeatedly applied along a circumferential direction of the ingot 11. Thereafter, in the first separation layer forming step S2, the laser beam is applied to positions P2 to P5 in the outer peripheral region A1 in the same manner while changing the output. In the first separation layer forming step S2, the separation layer 15 may be formed by sequentially applying the laser beam from the outer position to the inner position, contrary to the example of FIG. 6.

In the first separation layer forming step S2, the output of the laser beam is increased, for example, linearly, from the inner position to the outer position in the outer peripheral region A1 of the ingot 11. For example, when the output of the laser beam at the position P5 is set to 100%, the output at the positions P1 to P5 are set to 20%, 40%, 60%, 80%, and 100%.

The aspect in which the output of the laser beam changes from the inner position to the outer position is not limited to the aspect in which the output increases linearly, and may be, for example, an aspect in which the output gradually increases nonlinearly (for example, 10%, 20%, 35%, 60%, and 100%) or an aspect in which the output increases in steps (for example, 20%, 20%, 60%, 60%, and 100%).

As described above, in the first separation layer forming step S2, since the laser beam is applied such that the output at the outer position is higher than the output at the inner position in the outer peripheral region A1, the separation layer 15 exposed at the outermost peripheral edge 11c of the ingot 11 can be reliably formed. In the first separation layer forming step S2, since the output of the laser beam is lower at the inner position than at the outer position in the outer peripheral region A1 of the ingot 11, the output of the laser beam can be reduced as compared with a case where a high-power laser beam is uniformly applied to the outer peripheral region A1, and processing defects due to excessive output can be reduced.

Here, the output of the laser beam to be applied to the inner position in the outer peripheral region A1 in the first separation layer forming step S2 is preferably close to the output of the laser beam to be applied to the inner region A2 in the second separation layer forming step S3.

Specifically, the output of the laser beam to be applied to the inner position in the outer peripheral region A1 in the first separation layer forming step S2 is preferably equal to the output of the laser beam to be applied to the inner region A2 in the second separation layer forming step S3. The output in the inner region A2 does not need to be as high as the output in the outer peripheral region A1, and the output of the laser beam can be reduced by making the output at the inner position (specifically, the position P1) in the outer peripheral region A1 equal to the output in the inner region A2. The boundary between the outer peripheral region A1 and the inner region A2 of the ingot 11 can be satisfactorily processed.

The output of the laser beam to be applied to the inner position in the outer peripheral region A1 in the first separation layer forming step S2 may be less than the output of the laser beam to be applied to the inner region A2 in the second separation layer forming step S3. In this case, the same operation and effect as described above can be obtained.

FIGS. 7A and 7B are diagrams illustrating a first modification of the laser processing in the first separation layer forming step S2. FIG. 7A is a schematic diagram illustrating the laser processing on the ingot 11 as seen from the side, and FIG. 7B is a partially enlarged view of the outer peripheral region A1 of the ingot 11. In the first modification, the laser processing is performed using the laser beam applying mechanism 8 of the modification illustrated in FIG. 3.

In the first modification, the focal point of the laser beam to be applied in the first separation layer forming step S2 has a shape (for example, an elliptical shape) that extends in a direction from the inner position toward the outer position in the outer peripheral region A1 of the ingot 11. In the first separation layer forming step S2, the laser beam is repeatedly applied along the circumferential direction of the ingot 11.

In the first modification, in the first separation layer forming step S2, the laser beam is also applied to the outer peripheral region A1 such that the output at the outer position is higher than the output at the inner position in the outer peripheral region A1. The aspect in which the output of the laser beam changes from the inner position to the outer position can be various aspects as in the above embodiment.

According to the first modification, the laser processing can be performed from the inner position to the outer position in the outer peripheral region A1 of the ingot 11 by one application of the laser beam.

FIGS. 8A and 8B are diagrams illustrating a second modification of the laser processing in the first separation layer forming step S2. FIG. 8A is a schematic diagram illustrating the laser processing on the ingot 11 as seen from the side, and FIG. 8B is a partially enlarged view of the outer peripheral region A1 of the ingot 11. In the second modification, the laser processing is also performed using the laser beam applying mechanism 8 of the modification illustrated in FIG. 3.

In the second modification, the focal point of the laser beam to be applied in the first separation layer forming step S2 is branched into a plurality of points in a direction from the inner position toward the outer position in the outer peripheral region A1 of the ingot 11. In the first separation layer forming step S2, the laser beam is repeatedly applied along the circumferential direction of the ingot 11.

In the second modification, in the first separation layer forming step S2, the laser beam is also applied to the outer peripheral region A1 such that the output at the outer position is higher than the output at the inner position in the outer peripheral region A1. The aspect in which the output of the laser beam changes from the inner position to the outer position can be various aspects as in the above embodiment.

According to the second modification, the laser processing can be performed from the inner position to the outer position in the outer peripheral region A1 of the ingot 11 by one application of the laser beam.

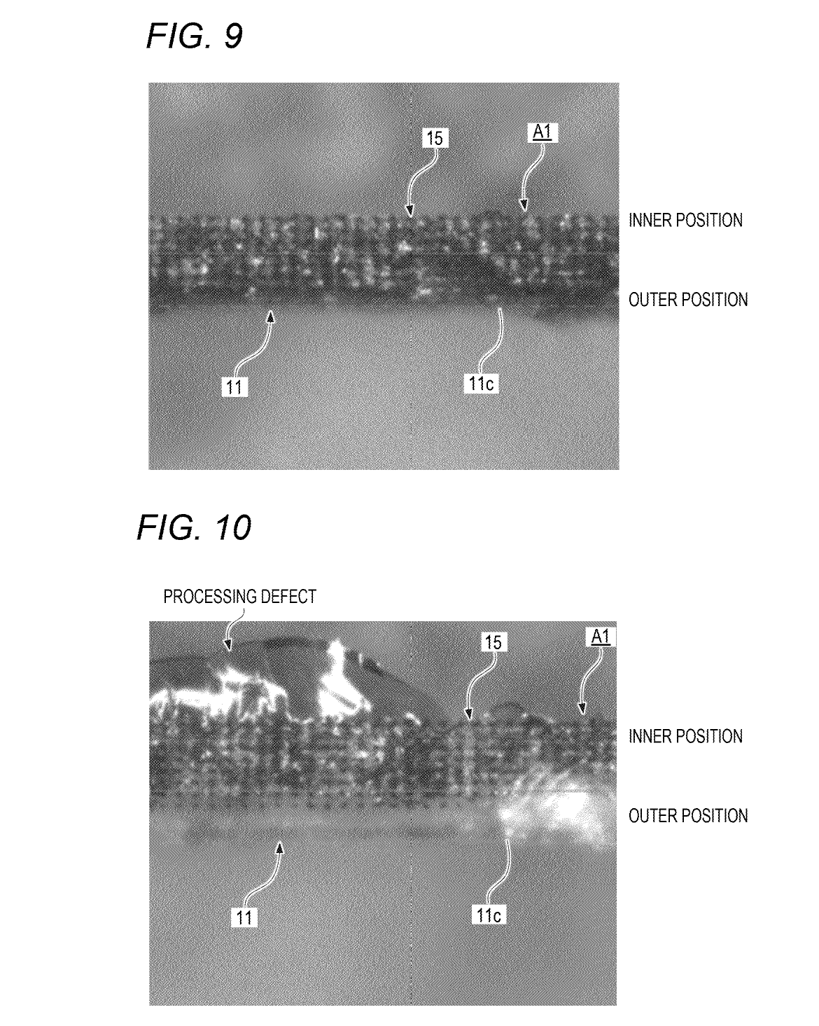

Next, with reference to FIGS. 9 and 10, experimental results will be described for a case where the laser beam is applied such that the output at the inner position is lower than the output at the outer position in the outer peripheral region A1 of the ingot 11 (FIG. 9) and a case where a high-power laser beam is uniformly applied to the outer peripheral region A1 (FIG. 10).

In both experiments, a GaN ingot 11 was used. In both experiments, the laser processing apparatus 1 including the laser beam applying mechanism 8 according to the modifications described above was used, and the laser processing was performed by branching the focal point of the laser beam into a plurality of points (here, the number of branches was 10) as in the second modification described above.

In the experimental example illustrated in FIG. 9, when the output of the laser beam at the outermost focal position was set to 100%, the output at the innermost focal position was set to 10%, and the output was linearly increased outward by 10%. As illustrated in FIG. 9, it can be seen that the separation layer 15 was uniformly formed from the outer position to the inner position in the outer peripheral region A1 of the ingot 11.

In the experimental example illustrated in FIG. 10, a processing defect region was formed near the inner position of the outer peripheral region A1. This is presumably because the output of the applied laser beam was excessive, causing abnormal cracks. In addition, it was observed that the separation layer 15 was not sufficiently formed at the outer position of the outer peripheral region A1.

As described above, in the first separation layer forming step S2, by applying the laser beam such that the output at the outer position is higher than the output at the inner position in the outer peripheral region A1, the separation layer 15 exposed at the outermost peripheral edge 11c of the ingot 11 can be reliably formed, and processing defects can be reduced.

### Second Separation Layer Forming Step

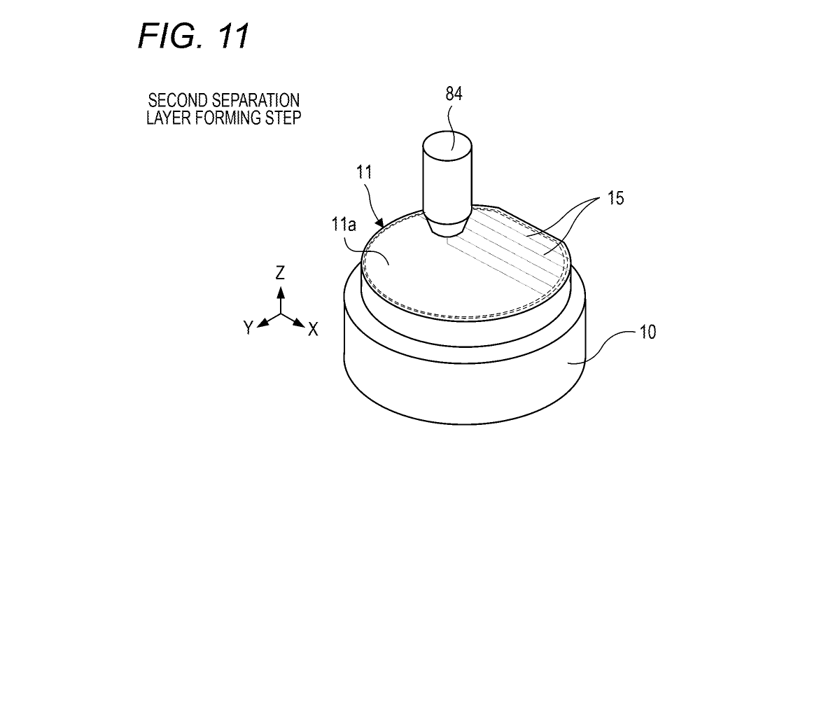

FIG. 11 is a diagram illustrating the second separation layer forming step S3. In the second separation layer forming step S3, the separation layer 15 is formed in the inner region A2 of the ingot 11 after the first separation layer forming step S2.

Specifically, in the second separation layer forming step S3, after the first separation layer forming step S2, the laser beam is applied to the inner region A2 of the ingot 11 with the focal point of the laser beam positioned at a predetermined depth position from the front surface 11a of the ingot 11, thereby forming the separation layer 15 in the inner region A2. For example, in the second separation layer forming step S3, a process is repeated in which the ingot 11 is fed such that the focal point moves from one end to the other end of the ingot 11 along the X-axis direction to form modified regions and cracks along the X-axis direction, and after the ingot 11 is moved by a predetermined amount in the Y-axis direction, the ingot 11 is fed such that the focal point moves from the other end to the one end of the ingot 11 along the X-axis direction to form modified regions and cracks along the X-axis direction. Accordingly, the separation layer 15 is formed inside the ingot 11.

The gas generated during the second separation layer forming step S3 is discharged to the outside of the ingot 11 from the separation layer 15 exposed on the side surface of the ingot 11 in the outer peripheral region A1. Therefore, the damage to the ingot 11 due to abnormal volume expansion of gas can be reduced during the laser processing.

### Separating Step

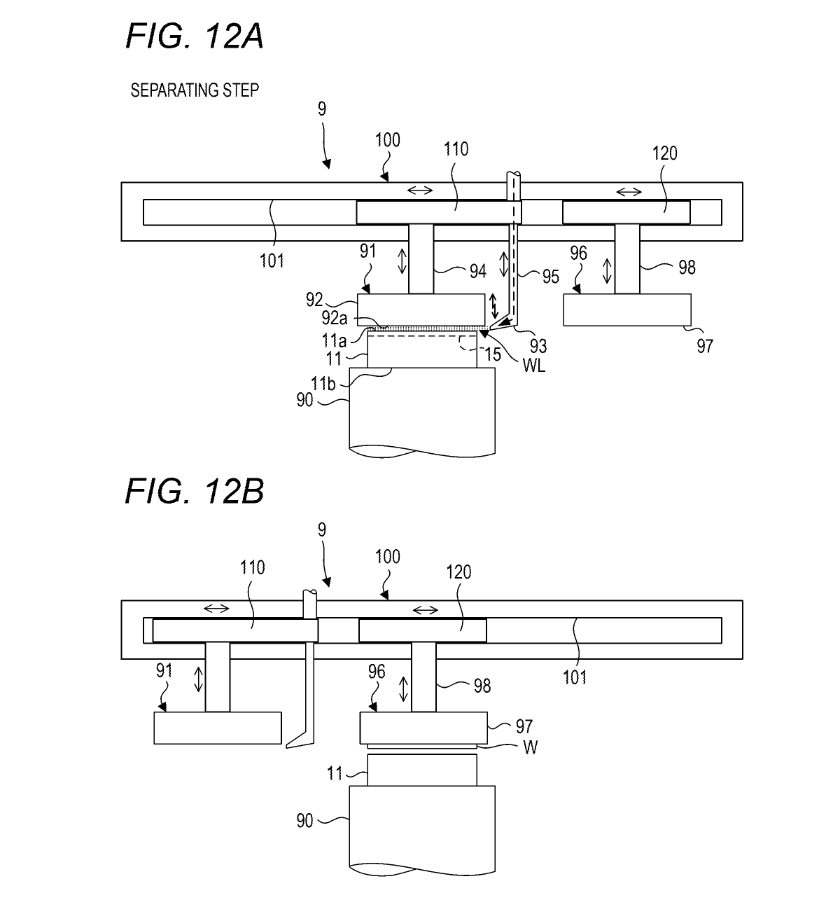

FIGS. 12A and 12B are diagrams illustrating the separating Step S4. FIG. 12A is a diagram illustrating a state in which ultrasonic waves are applied to the ingot 11, and FIG. 12B is a diagram illustrating a state in which the wafer W is separated from the ingot 11.

A separating apparatus 9 includes a cylindrical holding table 90 that holds the ingot 11 with the front surface 11a of the ingot 11 facing upward, an ultrasonic oscillation unit 91 that applies ultrasonic waves to the ingot 11, a separating unit 96 that separates the wafer W from the ingot 11, and a moving mechanism 100 that moves the ultrasonic oscillation unit 91 and the separating unit 96 in a horizontal direction.

For example, the holding table 90 holds the ingot 11 via an epoxy resin-based adhesive, or holds the ingot 11 under suction by a suction force generated by a suction source (not illustrated). The holding table 90 is rotatable about an axis that passes through a radial center and extends in a vertical direction.

A rectangular opening 101 extending in the horizontal direction is formed in the moving mechanism 100, and a moving piece 110 supporting the ultrasonic oscillation unit 91 and a moving piece 120 supporting the separating unit 96 are movable along the opening 101. Although not illustrated, the moving mechanism 100 includes a ball screw coupled to the moving pieces 110 and 120, a motor that rotates the ball screw, and the like.

The ultrasonic oscillation unit 91 includes an ultrasonic transducer 92 that applies ultrasonic waves to the ingot 11, a liquid supply nozzle 93 that supplies a liquid (for example, pure water) between the front surface 11a of the ingot 11 and the ultrasonic transducer 92, a transducer lifting mechanism 94 that adjusts a vertical position of the ultrasonic transducer 92, and a nozzle lifting mechanism 95 that adjusts a vertical position of the liquid supply nozzle 93. The transducer lifting mechanism 94 and the nozzle lifting mechanism 95 are implemented by air cylinders, ball screws, motors, and the like.

The ultrasonic transducer 92 has an end surface 92a facing the front surface 11a of the ingot 11. The ultrasonic transducer 92 is positioned by the transducer lifting mechanism 94 at a position where a small gap is provided between the end surface 92a and the front surface 11a of the ingot 11.

While ultrasonic waves are being applied to the ingot 11, the liquid supply nozzle 93 continuously supplies a liquid to the gap between the end surface 92a of the ultrasonic transducer 92 and the front surface 11a of the ingot 11 to form a liquid layer WL. The ultrasonic waves emitted from the ultrasonic transducer 92 are transmitted to the ingot 11 via the liquid layer WL, and extend the cracks of the separation layer 15 formed in the ingot 11. Accordingly, the strength of the separation layer 15 decreases.

The separating unit 96 includes a suction pad 97 that holds the wafer W to be separated from the ingot 11 under suction, and a pad lifting mechanism 98 that adjusts a vertical position of the suction pad 97. The pad lifting mechanism 98 is implemented by an air cylinder, a ball screw, a motor, and the like.

After ultrasonic waves are applied to the entire front surface 11a of the ingot 11, the moving pieces 110 and 120 move, and the suction pad 97 moves to a position facing the ingot 11 held on the holding table 90. Then, the separating unit 96 causes the suction pad 97 to suction the front surface 11a of the ingot 11 and moves the suction pad 97 upward, thereby separating, as the wafer W, a plate-shaped object including the front surface 11a of the ingot 11 from the separation layer 15 of the ingot 11.

The first separation layer forming step S2, the second separation layer forming step S3, and the separating step S4 as described above are repeatedly performed to produce a plurality of wafers W from the ingot 11.

As described above, in the wafer production method of the present embodiment, the output of the laser beam to be applied when forming the separation layer 15 in the outer peripheral region A1 of the ingot 11 can be reduced. Accordingly, processing defects of the ingot 11 in the first separation layer forming step S2 can be reduced, and as a result, the quality of the wafer W to be produced can be improved.

Although the embodiment of the present disclosure have been described above with reference to the accompanying drawings, it is needless to say that the present disclosure is not limited to the embodiment. It is obvious that those skilled in the art may come up with various changes or modifications within the scope of the claims, and it is understood that these naturally fall within the technical scope of the present disclosure. In addition, components in the embodiment described above may be freely combined without departing from the gist of the disclosure.

For example, the wafer production method of the embodiment described above has been described by taking the case where the workpiece is the ingot 11 as an example, but the present disclosure is not limited thereto, and the workpiece may be the wafer W, for example. That is, by performing the wafer production method of the embodiment described above on one wafer W, the one wafer W may be further divided into a plurality of wafers.

The present specification describes at least the following matters. Corresponding components and the like in the embodiment described above are shown in parentheses as an example, but the present disclosure is not limited thereto.

(1) A wafer production method for producing a wafer (wafer W) thinner than a workpiece (ingot 11, wafer W), which is a nitride or oxide semiconductor, from the workpiece, the wafer production method including:

a holding step (holding step S1) of holding the workpiece;

a first separation layer forming step (first separation layer forming step S2) of forming a separation layer (separation layer 15) in an outer peripheral region (outer peripheral region A1) of the workpiece held in the holding step by applying a pulsed laser beam having a wavelength that passes through the workpiece to the outer peripheral region of the workpiece, with a focal point of the laser beam positioned at a predetermined depth from a front surface of the workpiece;

a second separation layer forming step (second separation layer forming step S3) of forming a separation layer in an inner region (inner region A2) inside the outer peripheral region of the workpiece by applying the laser beam to the inner region with the focal point of the laser beam positioned at the predetermined depth from the front surface of the workpiece, after the first separation layer forming step; and

a separating step (separating step S4) of separating a plate-shaped object from the workpiece as the wafer with the separation layers formed in the first separation layer forming step and the second separation layer forming step as a start point, in which

in the first separation layer forming step, the laser beam is applied to the outer peripheral region such that the output at an outer position is higher than the output at an inner position in the outer peripheral region of the workpiece.

According to (1), in the first separation layer forming step, since the laser beam is applied such that the output at the outer position is higher than the output at the inner position in the outer peripheral region of the workpiece, the separation layer exposed at the outermost peripheral edge of the workpiece can be reliably formed, and gas generated inside the workpiece can be discharged to the outside. In the first separation layer forming step, since the output of the laser beam is lower at the inner position than at the outer position in the outer peripheral region of the workpiece, the output of the laser beam can be reduced, and processing defects due to excessive output can be reduced.

(2) The wafer production method according to (1), in which

the output of the laser beam to be applied to the inner position in the outer peripheral region in the first separation layer forming step is equal to or less than the output of the laser beam to be applied to the inner region in the second separation layer forming step.

According to (2), the output of the laser beam to be applied to the inner position in the outer peripheral region of the workpiece can be reduced. The boundary between the outer peripheral region and the inner region of the workpiece can be satisfactorily processed.

(3) The wafer production method according to (1) or (2), in which

the focal point of the laser beam to be applied in the first separation layer forming step has a shape that extends in a direction from the inner position toward the outer position.

According to (3), laser processing can be performed from the inner position to the outer position in the outer peripheral region of the workpiece by one application of the laser beam.

(4) The wafer production method according to (1) or (2), in which

the focal point of the laser beam to be applied in the first separation layer forming step is branched into a plurality of points in a direction from the inner position toward the outer position.

According to (4), laser processing can be performed from the inner position to the outer position in the outer peripheral region of the workpiece by one application of the laser beam.

### REFERENCE SIGNS LIST

11 ingot (workpiece)

15 separation layer

A1 outer peripheral region

A2 inner region

S1 holding step

S2 first separation layer forming step

S3 second separation layer forming step

S4 separating step

W wafer

What is claimed is:

1. A wafer production method for producing a wafer thinner than a workpiece, which is a nitride or oxide semiconductor, from the workpiece, the wafer production method comprising:
holding the workpiece;
forming a separation layer in an outer peripheral region of the workpiece held in the holding by applying a pulsed laser beam having a wavelength that passes through the workpiece to the outer peripheral region of the workpiece, with a focal point of the laser beam positioned at a predetermined depth from a surface of the workpiece;
forming a separation layer in an inner region inside the outer peripheral region of the workpiece by applying the laser beam to the inner region with the focal point of the laser beam positioned at the predetermined depth from the surface of the workpiece, after the forming of the separation layer in the outer peripheral region; and
separating a plate-shaped object from the workpiece as the wafer with the separation layers formed in the outer peripheral region and the inner region as a start point, wherein
in the forming of the separation layer in the outer peripheral region, the laser beam is applied to the outer peripheral region of the workpiece such that an output of the laser beam at an outer position in the outer peripheral region is higher than an output at an inner position in the outer peripheral region.

2. The wafer production method according to claim 1, wherein
the output of the laser beam to be applied to the inner position in the outer peripheral region in the forming of the separation layer in the outer peripheral region is equal to or less than an output of the laser beam to be applied to the inner region in the forming of the separation layer in the inner region.

3. The wafer production method according to claim 1, wherein
the focal point of the laser beam to be applied in the forming of the separation layer in the outer peripheral region has a shape that extends in a direction from the inner position toward the outer position.

4. The wafer production method according to claim 2, wherein
the focal point of the laser beam to be applied in the forming of the separation layer in the outer peripheral region has a shape that extends in a direction from the inner position toward the outer position.

5. The wafer production method according to claim 1, wherein
the focal point of the laser beam to be applied in the forming of the separation layer in the outer peripheral region is branched into a plurality of points in a direction from the inner position toward the outer position.

6. The wafer production method according to claim 2, wherein
the focal point of the laser beam to be applied in the forming of the separation layer in the outer peripheral region is branched into a plurality of points in a direction from the inner position toward the outer position.
